(19) United States
(12) Patent Application Publication
(10) Pub. No.: US 2012/0158288 A1
(43) Pub. Date: Jun. 21, 2012

(54) REAL-TIME PATH FINDING APPARATUS AND METHOD

(75) Inventors: Sung-June CHANG, Daejeon (KR); Hang-Kee KIM, Daejeon (KR); Chang-Joon PARK, Daejeon (KR)

(73) Assignee: Electronics and Telecommunications Research Institute, Daejon (KR)

(21) Appl. No.: 13/303,454

(22) Filed: Nov. 23, 2011

(30) Foreign Application Priority Data
Dec. 15, 2010 (KR) 10-2010-0128644

(51) Int. Cl. G01C 21/00

(52) U.S. Cl. 701/423

(57) ABSTRACT

Disclosed herein is a real-time path finding apparatus. The real-time path finding apparatus includes an input unit, an extraction unit, and an analysis unit. The input unit receives map-related information and real-time variation information. The extraction unit extracts path-finding information for performing path finding, from the map-related information and the real-time variation information. The analysis unit generates path-finding guidance by analyzing the map-related information of the path-finding information, and generates a path-finding route in consideration of the real-time variation information of the path-finding information together with the path-finding guidance.

### CROSS REFERENCE TO RELATED APPLICATION

This application claims the benefit of Korean Patent Application No. 10-2010-0128644, filed on Dec. 15, 2010, which is hereby incorporated by reference in its entirety into this application.

### BACKGROUND OF THE INVENTION

1. Technical Field

The present invention relates generally to a real-time path finding apparatus and method, and, more particularly, to a real-time path finding apparatus and method, which generates optimal path-finding guidance and takes into consideration situations which vary in real-time, so that unexpected situations can be reacted to while moving along a natural route, thereby providing excellent adjustment to a dynamic environment.

2. Description of the Related Art

Path-finding technologies using Artificial Intelligence (AI) have been used in various fields. Conventionally, path-finding technologies have been used for path finding for a robot. However, recently, such a path-finding technology has been used for path finding in the real world, such as for Global Positioning System (GPS) navigation, and in virtual worlds, such as in a game or a simulation, as well as for the path finding for robots. Therefore, the development of robot-related technology, navigation-related technology and game manufacturing technology has taken place alongside the development of path-finding technology using AI.

Although such a path-finding technology has been used in different fields, the path-finding technology for searching for an optimal route and following the optimal route can be applied to various fields which are different from each other, so that the importance of the path-finding technology has been increasing.

A conventional path-finding method includes a first method of extracting map information about a starting point, finding an optimal route based on the extracted map information and then using the optimal route as movement information, and includes a second method of changing a route by instantly reacting to one or more external inputs which are received when movement to a destination is simply performed. However, since the first method only allows movement along an optimized route, there is a problem in that it is difficult to react to unexpected situations that may occur in real time. Although the second method may provide excellent adaptability for dynamic environments, a route based on optimal path finding is not provided, so that there is a problem in that the entire path is not natural.

### SUMMARY OF THE INVENTION

An object of the present invention is to provide a real-time path finding apparatus and method, which generates optimal path-finding guidance and takes into consideration situations which vary in real time, so that unexpected situations can be reacted to while moving along a natural route, thereby providing excellent adjustment to a dynamic environment.

In order to accomplish the above object, the present invention provides a real-time path finding apparatus, including: an input unit for receiving map-related information and real-time variation information; an extraction unit for extracting path-finding information for performing path finding, from the map-related information and the real-time variation information; and an analysis unit for generating path-finding guidance by analyzing the map-related information of the path-finding information, and generating a path-finding route in consideration of the real-time variation information of the path-finding information together with the path-finding guidance.

The analysis unit may generate the path-finding route by adding the weight of the path-finding guidance to the weight of the real-time variation information of the path-finding information.

The analysis unit may generate the path-finding guidance including an optimal line by analyzing the map-related information of the path-finding information.

The analysis unit may generate the path-finding guidance using an A* algorithm.

The map-related information may include one or more elements selected from a group including a starting point, a destination point, a via point, an obstacle, and geographical information.

The real-time variation information may include information about occurrence of an obstacle and information about occurrence of an area which cannot be passed through.

The real-time path finding apparatus may further include a storage unit for storing the map-related information and the real-time variation information which were received from the input unit; and the extraction unit may extract path-finding information for performing path finding, from the map-related information and the real-time variation information stored in the storage unit.

The real-time path finding apparatus may further include a path-finding image generation unit for generating path-finding images using the path-finding route.

The real-time path finding apparatus may further include a path-finding image output unit for outputting the path-finding images.

In order to accomplish the above object, the present invention provides a real-time path finding method, including: receiving map-related information and real-time variation information; extracting path-finding information for performing path finding, from the map-related information and the real-time variation information; and generating path-finding guidance by analyzing the map-related information of the path-finding information, and generating a path-finding route in consideration of the real-time variation information of the path-finding information together with the path-finding guidance.

The generating the path-finding route may include generating the path-finding route by adding the weight of the path-finding guidance to the weight of the real-time variation information of the path-finding information.

The generating the path-finding guidance may include generating the path-finding guidance including an optimal line by analyzing the map-related information of the path-finding information.

The generating the path-finding guidance may include generating the path-finding guidance using an A* algorithm.

The map-related information may include one or more elements selected from a group including a starting point, a destination point, a via point, an obstacle, and geographical information.

The real-time variation information may include information about occurrence of an obstacle and information about occurrence of an area which cannot be passed through.

The real-time path finding method may further include storing the received map-related information and the real-time variation information; and the extracting the path-finding information may include extracting path-finding information for performing path finding, from the map-related information and the real-time variation information stored in the storage unit

The real-time path finding method may further include generating path-finding images using the path-finding route.

The real-time path finding method may further include outputting the path-finding images.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram schematically illustrating a real-time path finding apparatus according to an embodiment of the present invention;

FIG. 2 is a flowchart illustrating a real-time path finding method according to an embodiment of the present invention; and

FIGS. 3 to 5 are views illustrating an example in which path finding is performed using the real-time path finding apparatus and method according to an embodiment of the present invention.

### DESCRIPTION OF THE PREFERRED EMBODIMENTS

The present invention will be described in detail with reference to the accompanying drawings below. Here, when the description is repetitive and detailed descriptions of well-known functions or configurations would unnecessarily obscure the gist of the present invention, the detailed descriptions will be omitted. The embodiments of the present invention are provided to complete the explanation for those skilled in the art the present invention. Therefore, the shapes and sizes of components in the drawings may be exaggerated to provide a more exact description.

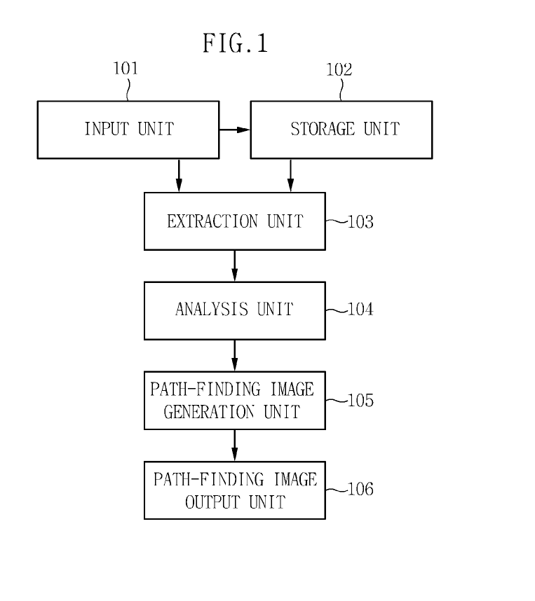

FIG. 1 is a diagram schematically illustrating a real-time path finding apparatus according to an embodiment of the present invention.

Referring to FIG. 1, the real-time path finding apparatus according to the embodiment of the present invention may include an input unit 101, a storage unit 102, an extraction unit 103, an analysis unit 104, a path-finding image generation unit 105, and a path-finding image output unit 106. The real-time path finding apparatus shown in FIG. 1 is made according to an embodiment, all the blocks of FIG. 1 are not essential elements, and some of the blocks may be added, modified, or removed in other embodiments. For example, a real-time path finding apparatus according to another embodiment may include the input unit 101, the extraction unit 103, the analysis unit 104, the path-finding image generation unit 105, and the path-finding image output unit 106 without the storage unit 102. Otherwise, a real-time path finding apparatus according to yet another embodiment may be configured without the path-finding image generation unit 105 and the path-finding image output unit 106, or may be configured without all of the storage unit 102, the path-finding image generation unit 105, and the path-finding image output unit 106.

The input unit 101 receives map-related information and information about variations in real time (hereinafter referred to as “real-time variation information”). Here, the map-related information may include one or more elements selected from a group including a starting point, a destination point, a via point, an obstacle, and geographical information. Further, the real-time variation information may include information about the occurrence of obstacles and information about the occurrence of an area which cannot be passed through. An “area which cannot be passed through” refers to an area which cannot be passed through because of construction or a change in the weather. The map-related information and the real-time variation information, which are input to the input unit 101, may be input by a user using an input device or may be input via wired or wireless communication.

The storage unit 102 stores the map-related information and the real-time variation information which were input using the input unit 110. The storage unit 102 performs a function of storing the pieces of information such that the information may be used to perform real-time path finding. The storage unit 102 may be a device capable of recording and storing information or data. For example, the storage unit 102 may include a hard disk drive, a compact disk, and a memory card.

The extraction unit 103 extracts path-finding information for performing path finding, from the map-related information and the real-time variation information. Since the map-related information and the real-time variation information include information which is not necessary to perform path finding, the extraction unit 103 performs a function of extracting information which is necessary to perform path finding, that is, path finding information. The extraction unit 103 may directly extract path-finding information from the information input to the input unit 101, and may extract the path-finding information from the information input to the storage unit 102.

The analysis unit 104 generates path-finding guidance by analyzing the map-related information of the path-finding information, and generates a path-finding route in consideration of the real-time variation information of the path-finding information together with the path-finding guidance. The analysis unit 104 first generates path-finding guidance by analyzing the map-related information of the path-finding information. In an embodiment, the analysis unit 104 may generate the path-finding guidance including an optimal line by analyzing the map-related information of the path-finding information. Here, the analysis unit 104 may generate the path-finding guidance using an A* algorithm. The A* algorithm guarantees that the shortest route from a starting point to a destination can be determined. The A* algorithm is one of graphic/tree search algorithms used to determine the shortest route from a given starting point node to a destination node in the field of computer science. That is, the A* algorithm corresponds to an algorithm which passes a test used to determine the shortest route to the given destination node. This algorithm uses a method of grading heuristic estimation values h(x) which are ranking values with respect to respective nodes x, such a ranking value being used to estimate the optimal route which passes through the corresponding node. According to this algorithm, nodes are visited in the order of the heuristic estimation values. Therefore, the A* algorithm may be classified as an example of a best-first search.

This algorithm was first written by Peter Hart, Nils Nilsson, and Bertram Raphael in 1968. The thesis written by these three people referred to this algorithm as “algorithm A”. If this algorithm is used with an appropriate heuristic value, the algorithm becomes optimal. Therefore, this algorithm is called the A* algorithm.

Although the case when the A* algorithm is used in order to generate path-finding guidance is illustrated as an example in the real-time path finding apparatus according to the embodiment of the present invention, it is apparent that any high-speed search algorithm, which can be used to search for a route over an entire area, may be used

After the optimal path-finding guidance is generated, the analysis unit 104 generates a path-finding route in consideration of the real-time variation information of the path-finding information together with the path-finding guidance. That is, the analysis unit 104 may change a path-finding route in consideration of the real-time variation information while the path-finding route is based on the optimal path-finding guidance. For this purpose, the analysis unit 104 may generate the path-finding route by adding the weight of the path-finding guidance and the weight of the real-time variation information of the path-finding information.

As described above, when path-finding guidance is generated and a route is generated in such a way as to couple the real-time variation information to the path-finding guidance, real-time information may be considered unlike existing methods which simply depend on the path-finding guidance, and optimal path-finding information may be considered unlike a method of only considering real-time information while performing simple movement to a destination point, thereby enabling the path finding to be more natural.

The path-finding image generation unit 105 generates path-finding images using the path-finding route generated using the analysis unit 104. That is, the path-finding image generation unit 105 performs a conversion operation used to reproduce the path-finding route using images.

The path-finding image output unit 106 outputs the path-finding images generated using the path-finding image generation unit 105. The path-finding image output unit 106 may output the path-finding images using characters and avatars.

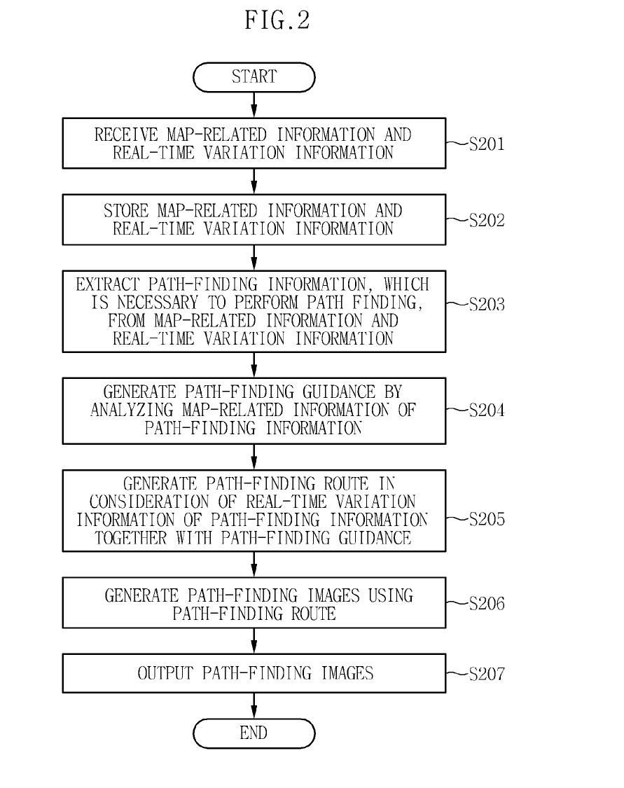

FIG. 2 is a flowchart illustrating a real-time path finding method according to an embodiment of the present invention.

Referring to FIG. 2, when the real-time path finding method according to the embodiment of the present invention starts, the map-related information and the real-time variation information are first received at step S201. Here, the map-related information may include one or more elements selected from a group including a starting point, a destination point, a via point, an obstacle, and geographical information. Further, the real-time variation information may include information about the occurrence of obstacles and information about the occurrence of an area which cannot be passed through.

When the map-related information and the real-time variation information are received at step S201, the map-related information and the real-time variation information are stored at step S202. At step S202, the map-related information and the real-time variation information may be stored on a device, such as a hard disk drive, a compact disk and a memory card, capable of recording and storing information or data.

Thereafter, path-finding information which is necessary to perform path finding is extracted from the map-related information and the real-time variation information at step S203. Here, the path-finding information may be directly extracted from the information received at step S201, and the path-finding information may be extracted from information received at step S202.

When the path-finding information is extracted at step S203, path-finding guidance is generated by analyzing the map-related information of the path-finding information at step S204. Here, in an embodiment, the path-finding guidance which includes an optimal line may be generated by analyzing the map-related information of the path-finding information. Here, the path-finding guidance may be generated using the A* algorithm.

When the path-finding guidance is generated at step S204, a path-finding route is generated in consideration of the real-time variation information of the path-finding information together with the path-finding guidance at step S205. Here, in an embodiment, the path-finding route may be generated by adding the weight of the path-finding guidance and the weight of the real-time variation information of the path-finding information.

Thereafter, path-finding images may be generated using the path-finding route generated as described above at step S206, and then the path-finding images may be output at step S207. That is, a conversion operation may be performed to reproduce the path-finding route using images at step S206, and then the path-finding images may be output using characters or avatars at step S207.

Since the real-time path-finding process is performed in the real-time path finding method shown in FIG. 2 as in the real-time path finding apparatus according to the embodiment of the present invention shown in FIG. 1, the description in FIG. 1 is applied without providing any further description thereof unless separate mention is provided. In FIG. 2, all the steps of the flowchart shown in FIG. 2 are not essential steps as they were in FIG. 1, and some of the steps may be added, modified, or removed in other embodiments. For example, according to another embodiment, the flowchart may include steps S201, S203, S204, S205, S206 and S207 without including step S202. Further, in yet another embodiment, the flowchart may not include step S206 or step S207, or may not include steps S202, S206, and 207. Further, each step of the flowchart is not limited to the illustrated order and the order of the steps may be modified or changed if necessary.

The real-time path finding method according to the embodiment of the present invention may be implemented using a program and stored on a computer readable recording medium, such as a Compact Disc Read Only Memory (CD-ROM), Random Access Memory (RAM), ROM, a floppy disk, a hard disk, or a magneto-optical disk.

The above-described real-time path finding method has been described with reference to the flowchart shown in the drawing. Although the method is illustrated and described using a series of steps for the sake of making the description brief, the present invention is not limited to the order of the steps. Some of the steps may be performed with other steps in an order which is different from the order illustrated and described in the present specification, or may be may be performed simultaneously with other steps. Various types of branches, flow routes, and the order of the steps which obtain the same or similar results may be implemented. Further, all the steps which were illustrated may not be required in order to implement the method which has been described in the present specification.

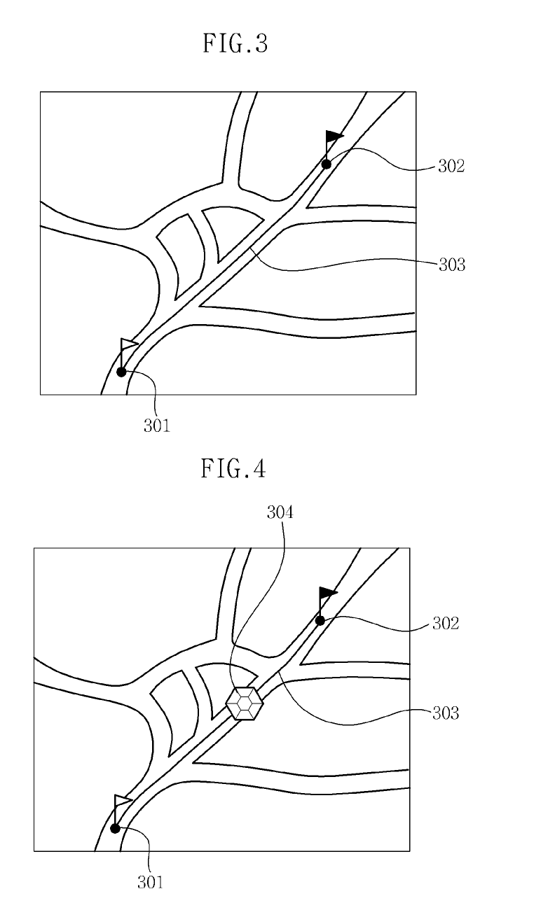

FIGS. 3 to 5 are views illustrating an example in which path finding is performed using the real-time path finding apparatus and method according to an embodiment of the present invention.

FIGS. 3 to 5 illustrate the example in which path finding is performed using the real-time path finding apparatus and method according to the embodiment of the present invention in order to understand the present invention.

FIG. 3 illustrates an example in which the real-time path finding apparatus and method according to the embodiment of the present invention generates path-finding guidance by analyzing the map-related information of the path-finding information. Referring to FIG. 3, a starting point 301 and a destination point 302 are displayed, and an optimal path 303, calculated based on the starting point 301 and the destination point 302, is displayed using a line. The route may be calculated and then displayed using an appropriate method if necessary. For example, the route may be calculated and displayed using the A* algorithm.

FIG. 4 illustrates an example in which an obstacle 304 has occurred on the optimal path 303 in real time in the real-time path finding apparatus and method according to the embodiment of the present invention. According to the real-time path finding apparatus and method according to the embodiment of the present invention, it is necessary to change the path 303 in consideration of the obstacle 304 which may occur in real time. Although FIG. 4 illustrates the occurrence of the obstacle 304 as a situation which varies in real time (hereinafter referred to as “real-time variation situation”), such a real-time variation situation may include the case when an originally established route cannot be passed through because of construction or a change in the weather as well as because of the occurrence of the obstacle 304.

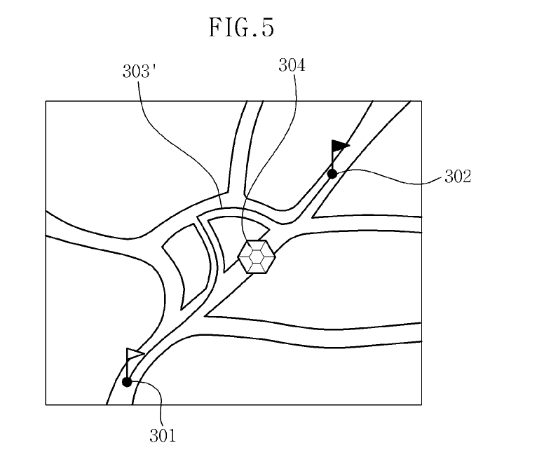

FIG. 5 illustrates an example in which a new path 303′ is generated and displayed in consideration of the real-time variation information of the path-finding information by the real-time path finding apparatus and method according to the embodiment of the present invention. Referring to FIG. 5, when the obstacle 304 occurs, an optimal route is calculated in consideration of the obstacle, and then the new path 303′ is displayed.

It can be seen by referring to FIGS. 3 to 5 that, when the real-time path finding apparatus and method according to the embodiment of the present invention is used, the optimal path-finding guidance is generated and a route may be changed while moving along a natural route in consideration of the real time variation situation.

As described above, the above-described real-time path finding apparatus and method according to the embodiment of the present invention is not limited to path finding in the real world, but may be applied to path finding in a virtual world such as in a game or simulation.

According to an aspect of the present invention, it is possible to provide a real-time path finding apparatus and method, which generates optimal path-finding guidance and takes into consideration situations which vary in real time, so that unexpected situations can be reacted to while moving along a natural route, thereby providing excellent adjustment to a dynamic environment.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A real-time path finding apparatus, comprising:
an input unit for receiving map-related information and real-time variation information;
an extraction unit for extracting path-finding information for performing path finding, from the map-related information and the real-time variation information; and
an analysis unit for generating path-finding guidance by analyzing the map-related information of the path-fording information, and generating a path-fording route in consideration of the real-time variation information of the path-fording information together with the path-finding guidance.

2. The real-time path finding apparatus as set forth in claim 1, wherein the analysis unit generates the path-fording route by adding a weight of the path-finding guidance to a weight of the real-time variation information of the path-finding information.

3. The real-time path finding apparatus as set forth in claim 1, wherein the analysis unit generates the path-fording guidance including an optimal line by analyzing the map-related information of the path-finding information.

4. The real-time path finding apparatus as set forth in claim 1, wherein the analysis unit generates the path-finding guidance using an A* algorithm.

5. The real-time path fording apparatus as set forth in claim 1, wherein the map-related information includes one or more elements selected from a group including a starting point, a destination point, a via point, an obstacle, and geographical information.

6. The real-time path finding apparatus as set forth in claim 1, wherein the real-time variation information includes information about occurrence of an obstacle and information about occurrence of an area which cannot be passed through.

7. The real-time path finding apparatus as set forth in claim 1, further comprising a storage unit for storing the map-related information and the real-time variation information which were received from the input unit; and
wherein the extraction unit extracts path-finding information which is necessary to perform path finding from the map-related information and the real-time variation information stored in the storage unit.

8. The real-time path finding apparatus as set forth in claim 1, further comprising a path-finding image generation unit for generating path-finding images using the path-finding route.

9. The real-time path finding apparatus as set forth in claim 8, further comprising a path-finding image output unit for outputting the path-finding images.

10. A real-time path finding method, comprising:
receiving map-related information and real-time variation information;
extracting path-finding information for performing path finding, from the map-related information and the real-time variation information; and
generating path-finding guidance by analyzing the map-related information of the path-finding information, and generating a path-finding route in consideration of the real-time variation information of the path-finding information together with the path-finding guidance.

11. The real-time path finding method as set forth in claim 10, wherein the generating the path-finding route comprises generating the path-finding route by adding a weight of the path-finding guidance to a weight of the real-time variation information of the path-finding information.

12. The real-time path finding method as set forth in claim 10, wherein the generating the path-finding guidance comprises generating the path-finding guidance including an optimal line by analyzing the map-related information of the path-finding information.

13. The real-time path finding method as set forth in claim 10, wherein the generating the path-finding guidance comprises generating the path-finding guidance using an A* algorithm

14. The real-time path finding method as set forth in claim 10, wherein the map-related information includes one or more elements selected from a group including a starting point, a destination point, a via point, an obstacle, and geographical information.

15. The real-time path finding method as set forth in claim 10, wherein the real-time variation information includes information about occurrence of an obstacle and information about occurrence of an area which cannot be passed through.

16. The real-time path finding method as set forth in claim 10, further comprising storing the received map-related information and the real-time variation information; and
wherein the extracting the path-finding information comprises extracting path-finding information which is necessary to perform path finding from the map-related information and the real-time variation information stored in the storage unit

17. The real-time path finding method as set forth in claim 10, further comprising generating path-finding images using the path-finding route.

18. The real-time path finding method as set forth in claim 17, further comprising outputting the path-finding images.
